(19) United States
(12) Patent Application Publication
(10) Pub. No.: US 2018/0160634 A1
(43) Pub. Date: Jun. 14, 2018

(54) DEVICE AND METHOD OF THINNING GRAPE VINE SHOOTS

(71) Applicant: Jared Abate, San Miguel, CA (US)

(72) Inventor: Jared Abate, San Miguel, CA (US)

(21) Appl. No.: 15/376,001

(22) Filed: Dec. 12, 2016

(51) Int. Cl. A01G 17/02; A01G 17/00; G05B 19/05

(52) U.S. Cl. CPC A01G 17/023; A01G 17/005; G05B 2219/13004; G05B 19/056; A01G 17/026

(57) ABSTRACT

A device and method of thinning grape vine shoots comprises a Normalized Differential Vegetative Index (NDVI) sensor. Further, the device comprises a shoot removal whip assembly configured to remove at least one grape vine shoot per stroke. Further, the device comprises a programmable logic controller (PLC) to control the shoot removal whip assembly, the programmable logic controller comprising a memory unit and a processor. Further, the memory unit stores information regarding optimal shoot height and density parameters, and a set of program modules. The processor contained in the PLC takes readings of shoot height and density via the NDVI sensor, and sends an output to a proportional hydraulic valve. The PLC also takes an input from an adjustable gain potentiometer, which allows the user to increase or decrease the acceptable shoot parameters. Via the signal sent to the proportional hydraulic valve, the PLC controls the shoot removal whip assembly, in order to remove a variable number of shoots. This variable shoot removal can be any number from 0 to 25, in any given area along the grape vine. This variable control of the removal whip assembly results in a grape vine that has a balanced number and density of growth shoots.

### BACKGROUND OF THE INVENTION

A. Technical Field

The present invention generally relates to the technical field of mechanical thinning in agriculture, and more specifically mechanical thinning of grape vine shoots.

B. Description of Related Art

In Viticulture, grape vines often have a high vigor growth, leading to either a high-density canopy throughout the vine, or un-balanced growth throughout the vine. Depending on varietal and farming technique, it is often necessary to remove many shoots throughout the entire vine canopy, or in certain higher density shoot number areas. This removal of canopy shoots is referred to as shoot thinning, and usually takes place during the beginning months of the growing season. Shoot thinning is often performed in order to conform a vine to a desired uniform spacing for maximum fruit quality. In one example, farmers and hand crews, thin the crops by hand. Cost of hand thinning is steadily increasing due to a multitude of factors. These factors comprise declining availability of laborers and increasing government minimum wage standards. As a result, reducing hand labor can increase savings for farmers and growers.

Therefore, there is a need in the art for a device and method of mechanically thinning grape vine shoots, as to save on labor costs, without under or over-thinning specific areas throughout the entire grape vine.

### SUMMARY OF THE INVENTION

The present invention relates to a device and method for thinning grape vine shoots, which detects shoot size throughout the vine and adjusts the thinning accordingly.

The unique design of the present invention, a device for thinning grape vine shoots, comprises a Normalized Differential Vegetative Index (NDVI) sensor, a shoot-removal whip assembly, and a programmable logic controller or “PLC”. The shoot removal whip is configured to remove at least one grape vine shoot when activated. In short, the programmable logic controller controls the shoot removal whip assembly. Further, the programmable logic controller handles logic and processing of information with a pre-defined algorithm. The algorithm processes the input and output data, and constantly relays a command signal to a hydraulic valve controlling the shoot removal whip assembly. The hydraulic valve uses the command signal from the programmable logic controller to control hydraulic oil flow to the shoot removal whip assembly. The whipping assembly, therefore, removes a certain number of shoots, in relation to the relative density of the grape vine shoot count. The programmable logic controller (PLC) comprises a memory unit, and a processor, programmed with a pre-defined control algorithm. The PLC is a “real-time” system, which produces output results in response to input conditions. In one instance of the current invention, the input conditions is an NDVI value, ranging from 0.001 to 1.000 dimensionless units. This NDVI value is a measurement of the grape vine shoots currently being read by the NDVI sensor, as the thinning system makes its way down the vineyard rows. The PLC module processes the information regarding at least one grape vine shoot to generate a plurality of grape vine shoot parameters. An adjustable gain potentiometer, which allows the operator to adjust the shoot removal size threshold, inputs a value into the PLC algorithm. The control algorithm continually processes the real-time NDVI value. The PLC continually generates a command signal to the hydraulic control valve, which in turn eliminates either: no shoots, one shoot, or many shoots, in a specific area of the vine. The rotational speed of the shoot-removal whipping assembly can be varied by the hydraulic control valve from 0 rotations per second, upwards to 20 rotations per second. If commanded not to activate, i.e. the shoot length and density is not deemed needing thinning, the removing assembly will not remove any shoots. Furthermore, one unique, key aspect of the current invention is that short, low growth (density) areas of the vine are left untouched by the machine while high growth (density) areas are thinned appropriately; thus balancing the vine to a desirable condition.

In one embodiment of the present invention, information regarding the plurality of optimal grape vine shoot parameters comprises of at least one of: an optimal distance from adjacent grape vine shoots on a grape vine (density), an optimal length of the grape vine shoot, optimal position of the grape vine shoots. The combination of these parameters makes up the present referred to “canopy size”. In one example, the NDVI Sensor takes a reading of grape vine shoot size and density, and sends a number varying from 0.001 to 1.000 back to the programmable logic controller. The shoot count and size throughout a grape vine is key among the plurality of grape vine shoot parameters.

### BRIEF DESCRIPTION OF DRAWINGS

FIG. 1 is a block diagram of a device for thinning grape vine shoots in accordance with various embodiments of the invention.

FIG. 2 is a block diagram of a programmable logic controller in accordance with various embodiments of the invention.

FIG. 3 is flow chart of a method of thinning grape vine shoots, according to yet another embodiment of the present invention.

FIG. 4 is an exemplary illustration of working of a device for thinning grape vine shoots according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

The scope of the invention is, therefore, indicated by the appended claims rather than by the foregoing description. All changes that come within the meaning and range of equivalency of the claims are to be embraced within their scope.

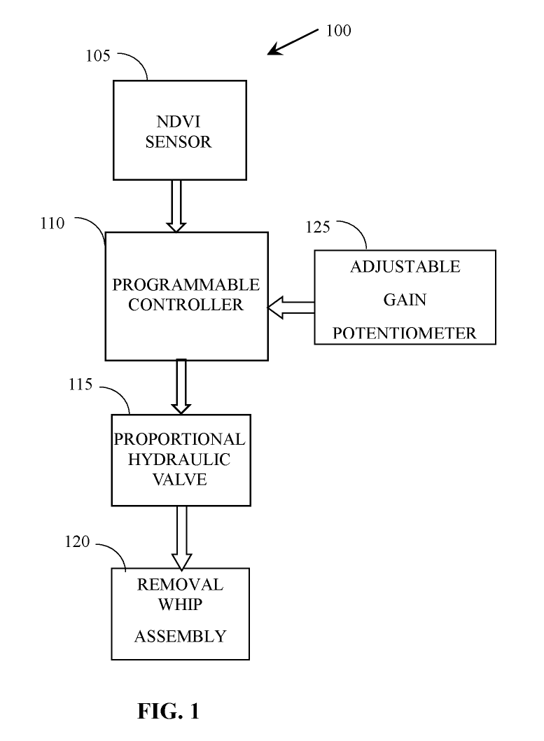

FIG. 1 is a block diagram of a device 100 for thinning grape vine shoots in accordance with which various embodiments of the present invention are implemented. The device 100 comprises a Normalized Differential Vegetative Index (NDVI) sensor 105, a programmable logic controller 110, a proportional hydraulic control valve 115, a shoot removal whip assembly 120, an adjustable gain potentiometer 125. In one example, the device 100 further comprises a GPS speed sensor (not shown) to enable exact shoot contact with the shoot removal whip assembly 115. The shoot removal whip assembly 115 is configured to cut at least one grape vine shoot per stroke per revolution. The Normalized Differential Vegetative Index (NDVI) sensor 105 senses real-time presence, and location of grape vine shoots throughout the grape vine. Further, the NDVI sensor 105 senses shoot size and density of at least one grape vine shoot by sensing infrared nitrogen content of the grape vine. In one example, the NDVI Sensor 105 takes a reading of shoot size, and sends a number varying from 0.001 to 1.000 back to the programmable logic controller. The shoot count and size throughout a grape vine is key among the plurality of grape vine shoot parameters.

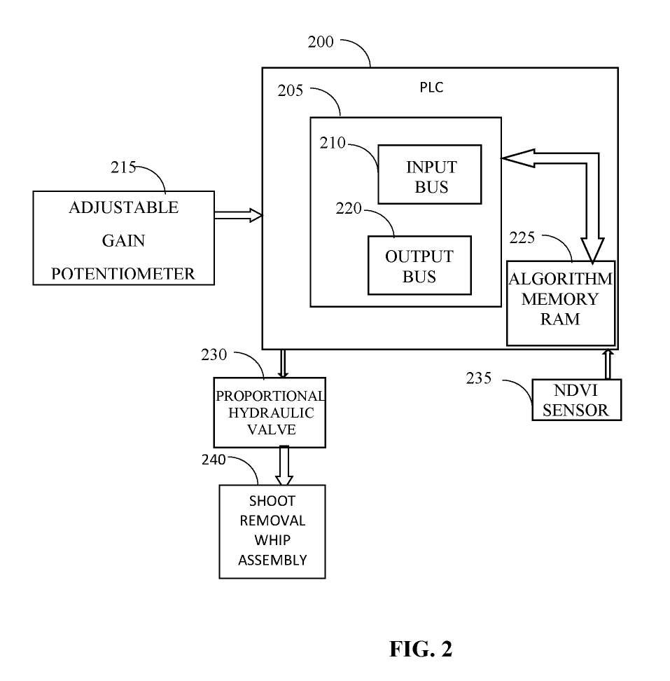

The NDVI sensor 105 differentiates a growing shoot on the vine from old vine wood, soil, etc. The NVDI sensor 105 senses information regarding at least one grape vine shoot. Further, the NVDI sensor 105 transmits information regarding at least one grape vine shoot to the programmable logic controller 110. The programmable controller 110 sends a command to the proportional hydraulic valve 115; in this instance a voltage reading from 0 to 10 Volts. The proportional hydraulic valve 115 controls the hydraulic flow to the removal whip assembly 120, which in rotates and removes shoots. A block diagram of the programmable logic controller 110 is exemplarily illustrated in FIG. 2.

Referring to FIG. 2, a programmable logic controller (PLC) 200 controls a proportional hydraulic control valve 230 (which in turn controls a shoot removal whip assembly 240), and receives input from a NDVI sensor 235 and an adjustable gain potentiometer 215. The NDVI sensor 235 senses presence and location of grape vine shoots growing on the grape vines. The NDVI sensor 235 differentiates a grape vine shoot from old wood, soil, etc. The NVDI sensor 235 senses information regarding at least one grape vine shoot. Further, the NVDI sensor 235 transmits constant data to the PLC 200 in accordance with shoot size and density. In one example, the programmable logic controller 200 is a microcontroller. The programmable logic controller 200 comprises an algorithm memory RAM 225 and a processor 205. The algorithm memory RAM 225 stores an algorithm for determining a plurality of optimal grape vine shoot parameters, and a set of program modules. Information regarding the plurality of optimal grape vine shoot parameters comprises at least one of: an optimal distance from adjacent grape vine shoots throughout a grape vine in a cultivation field, an optimal size of the grape vine shoots, and an optimal density of the grape vine shoot. The processor 205 executes the set of program modules. The PLC receives data via the Input Bus module 210 and transmits data via the Output Bus module 220. The input bus module 210, executed by the processor 205, is configured to receive information regarding at least one grape vine shoot via the NDVI sensor 235. The processor 205, is configured to process the information regarding at least one grape vine shoot to generate an output value to the proportional hydraulic valve 230. The processor transmits data from the Output Bus module 220 to the proportional hydraulic valve 230. Further, the processor 205, via the proportional hydraulic valve 230 and shoot removal whip assembly 240, removes an x number of grape vine shoots, based upon the input values being unequal to the optimal grape vine shoot parameters in a particular area of the grape vine. Whereas “x” is a positive integer greater or equal to zero, corresponding to shoots. The adjustable gain potentiometer 215 allows the user to increase or decrease the optimal shoot parameters, & sends a value to the processor 205 via the Input Bus module 210. In one example, the programmable logic controller 200 controls rotational speed of the shoot removal whip assembly 240 and thereby controls thinning rate.

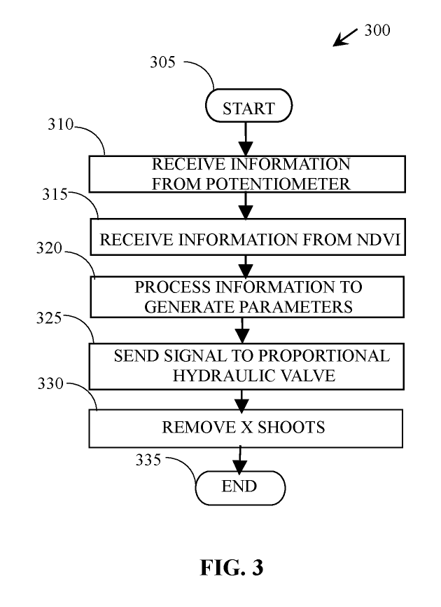

FIG. 3 is a flow chart of method 300 of thinning grape vine shoots in accordance with which various embodiments of the present invention are implemented. The method 300 is implemented in a device. The device comprises a Normalized Differential Vegetative Index (NDVI) sensor, a programmable logic controller, and a shoot removal whip assembly. The shoot removal whip assembly is configured to cut at least one grape vine shoot per stroke. TheNormalized Differential Vegetative Index (NDVI) sensor senses presence, location, and size of grape vine shoots growing on a grape vine in a cultivation field. Further, the NDVI sensor senses shoot size and density of at least one grape vine shoot by sensing infrared nitrogen content of the growing shoot. The NDVI sensor differentiates a grape vine canopy from old wood, soil, etc. The NVDI sensor senses information regarding at least one grape vine shoot. Further, the NVDI sensor transmits information regarding at least one grape vine shoot to the programmable logic controller. The programmable logic controller controls the shoot removal whip assembly via the proportional hydraulic valve and receives input from the NDVI sensor. The programmable logic controller comprises a memory unit and a processor. The memory unit stores information regarding a plurality of optimal grape vine shoot parameters, and a set of program modules. The processor executes the set of program modules. The set of program modules comprises an input bus module and an output bus module. Information regarding the plurality of optimal grape vine shoot parameters comprises at least one of: an optimal distance from adjacent grape vine shoots throughout a grape vine in a cultivation field, an optimal size of the grape vine shoots, and an optimal density of the grape vine shoot. The method 300 commences at step 305.

At step 310, the programmable logic controller receives information from the external gain potentiometer sensor, adjustable by the operator. The potentiometer varies a voltage resistance reading from the PLC, which allows the thinning rate to be decreased or increased relatively.

At step 315, the input module, executed by the processor, receives information regarding at least one grape vine shoot via the NDVI sensor. In one example, the NDVI Sensor takes a reading of grape vine shoot size, and sends a number varying from 0.00 to 0.99 back to the programmable logic controller.

At step 320, the processor compares the output value from the NDVI sensor, 0.00-0.99 to the optimal grape vine shoot parameters, modified by the gain potentiometer. The processor determines the output command value to send to the proportional hydraulic valve.

At step 325, the processor sends a command via the output bus module to the proportional hydraulic valve to adjust desired thinning rate determined by the PLC. In one instance, the output to the proportional valve varies from 1.0 to 10.0

At step 330, the shoot removal whip assembly, if activated via the PLC, receives hydraulic oil and removes the appropriate amount of shoots.

The method 300 ends at step 335. The process restarts and shoot removal constantly varies as the device moves down the vineyard row on a vehicle.

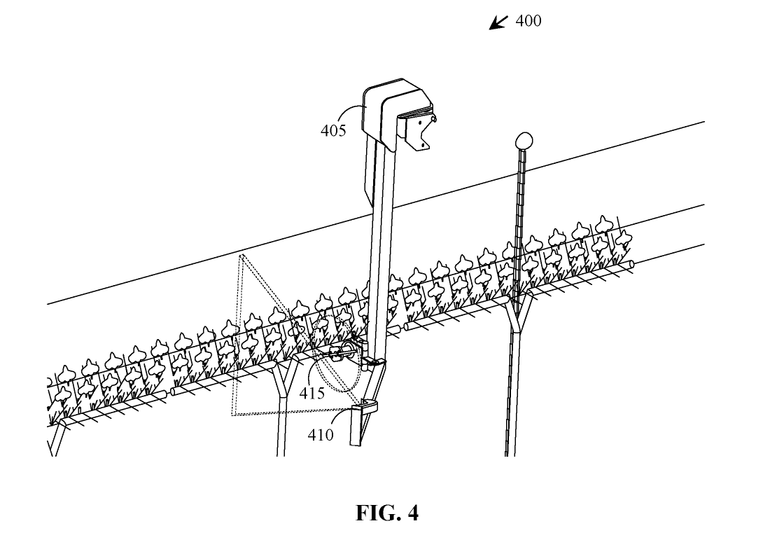

FIG. 4 is an exemplary illustration of a working device 400 for thinning grape vine shoots according to yet another embodiment of the present invention. The device 400 comprises a Normalized Differential Vegetative Index sensor (NDVI) 410 and a shoot removal whip assembly 415 and a programmable logic controller (not shown). In one example, the shoot removal whip assembly 415 comprises a removal whip mounted on a hub torsionally coupled to a hydraulic motor. The NDVI sensor 410 is mounted forward of the removal whip and motor, in order to take readings of the shoots before the removal whip reaches said shoots. The device 400 is mounted on a moving vehicle via a supporting arm and weldment 405.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A device for thinning grape vine shoots, the device comprising:
a Normalized Differential Vegetative Index (NDVI) sensor;
a shoot removal whip assembly configured to cut at least one grape vine shoot per stroke; and
a programmable logic controller to control the shoot removal whip assembly, the programmable logic controller comprising:
a memory unit to store information regarding a plurality of optimal grape vine shoot parameters, and a set of program modules, and
a processor to execute the set of program modules, wherein the set of program modules comprises:
an input module, executed by the processor, configured to receive information regarding at least one grape vine shoot via the NDVI sensor, as well as information from the user-controlled thinning gain potentiometer sensor,
whereas the processor processes information regarding at least one grape vine shoot to generate a plurality of grape vine shoot parameters related to at least one grape vine shoot, and cut at least one grape vine shoot per stroke based on the plurality of the grape vine shoot parameters related to at least one grape vine shoot being unequal to the plurality of optimal grape vine shoot parameters.
an output bus module, executed by the processor, configured to output a control command to a proportional hydraulic valve, and
a shoot removal whip assembly comprising of a removal apparatus coupled to a hydraulic motor.

2. The device of claim 1, wherein information regarding the plurality of optimal grape vine shoot parameters comprises at least one of: an optimal distance from adjacent grape vine shoots throughout a grape vine in a cultivation field, an optimal size of the grape vine shoots, and an optimal density of the grape vine shoot.

3. The device of claim 1, wherein the device is mountable on a vehicle.

4. A method of thinning grape vine shoots, the method comprising:
storing, in a memory unit, information regarding a plurality of optimal grape vine shoot parameters, and a set of program modules;
receive information regarding at least one grape vine shoot via an NDVI sensor controlled by a processor in a programmable logic controller;
processing, by the processor via a output bus module, the information regarding at least one grape vine shoot to generate a plurality of grape vine shoot parameters related to at least one grape vine shoot; and
cutting, by a shoot removal whip assembly controlled by the processor via the output bus module through a proportional hydraulic valve, when activated at least one grape vine shoot based on the plurality of the grape vine shoot parameters related to at least one grape vine shoot being unequal to the plurality of optimal grape vine shoot parameters.

5. The method of claim 4, wherein information regarding the plurality of optimal grape vine shoot parameters comprises at least one of an optimal distance from adjacent grape vine shoots in a cultivation field, an optimal quality of the grape vine shoots, and an optimal size of the grape vine shoot.

6. The method of claim 4, wherein the plurality of grape vine shoot parameters comprises at least one of a distance of at least one grape vine shoots from an adjacent grape vine shoot on a grape vine in the cultivation field, information regarding quality of at least one grape vine shoot, information regarding size of at least one grape vine shoot, and information regarding shoot length of at least one grape vine shoot.
